(19) United States
(12) Patent Application Publication
(10) Pub. No.: US 2013/0247121 A1
(43) Pub. Date: Sep. 19, 2013

(54) INTERACTION METHOD BETWEEN DIGITAL TELEVISION RECEPTION TERMINAL AND MOBILE TERMINAL, TERMINAL AND SYSTEM

(71) Applicant: Ming Yuan, Shenzhen (CN)

(72) Inventor: Ming Yuan, Shenzhen (CN)

(21) Appl. No.: 13/989,651

(22) PCT Filed: Feb. 28, 2011
(86) PCT No.: PCT/CN2011/071392

§ 371 Date: May 24, 2013

(30) Foreign Application Priority Data
Nov. 26, 2010 (CN) 201010561739.1

(51) Int. Cl. H04N 21/647

(52) U.S. Cl. CPC H04N 21/64707
USPC 725/110

(57) ABSTRACT

An interaction method between a digital television reception terminal and a mobile terminal, the terminal and a system are provided. The method includes the following steps: the mobile terminal acquires a first swinging control instruction of a user by a vector sensor; the mobile terminal transmits the title and the link address information of the current online playing video to the digital television reception terminal, according to said first swinging control instruction; and said digital television reception terminal acquires said playing video to play, according to said title and link address information. By means that the user swings the mobile terminal to initiate a video playing handoff, the invention realizes the video handoff between the mobile terminal and the digital television reception terminal by a convenient operation, and improves experience of the user while being user-friendly.

This application claims the benefit of priority to CHINA Patent Application No. 201010561739.1 filed with the Chinese Patent Office on Nov. 26, 2010 and entitled “INTERACTION METHOD BETWEEN DIGITAL TELEVISION RECEPTION TERMINAL AND MOBILE TERMINAL, TERMINAL AND SYSTEM”, the contents of which are incorporated herein by reference in their entirety.

### FIELD OF THE INVENTION

The invention relates to telecommunication technology filed, and more particularly, to an interaction method between a digital television reception terminal and a mobile terminal, the terminal and a system.

### BACKGROUND OF THE INVENTION

With the continuous development of communication technology, more and more applications can connect with the mobile network, the Internet, and the radio and television network, and merging of the networks will be progressively realized. As such, terminals in the three networks have more and more common functions, for example, set-up boxes have most functions of cell phones and personal computers. On the other hand, with the development of mobile Internet, more and more users start to use and love online video of cell phones. However, screen size of the cell phones is limited to meet the portability requirement of the cell phones. As such, experience of user is less than satisfactory when viewing the online video by the cell phones as the limited screen size. Therefore, users tend to prefer to watch the wished video by televisions.

At present, two means can be employed if the user wishes to view the interested online video on the cell phone by the television: (1) downloading the video, and playing the video by a player which is connected to the television; and (2) searching and playing the corresponding video by the set-up box.

However, both of the means require complicated operations and consumes lots of time to download and search video. The experience of user is also less than satisfactory.

### SUMMARY OF THE INVENTION

The technical problem to be solved by the invention is: to provide an interaction method between a digital television reception terminal and a mobile terminal, the terminal, and a system, which can facilitate users to play mobile phone online video by the digital television reception terminal instead of mobile phone, thereby improving experience of the user and making operations more interesting.

To solve the problem of the present invention, the invention discloses an interaction method between a digital television reception terminal and a mobile terminal.

To solve the problem of the invention, the invention discloses the interaction method between the digital television reception terminal and the mobile terminal, wherein the method includes:

the mobile terminal having a vector sensor acquires a first swinging control instruction of the user;

the mobile terminal transmits the title and the link address information of the current online playing video to the digital television reception terminal according to the first swinging control instruction; and

the digital television reception terminal acquires and plays the playing video according to the title and the link address information.

In addition, the method includes the following step before the mobile terminal having a vector sensor acquires a first swinging control instruction of the user:

the mobile terminal and the digital television reception terminal connect with each other through Wi-Fi and/or Bluetooth technologies.

In addition, the step that the mobile terminal having the vector sensor acquires the first swinging control instruction of the user includes:

the mobile terminal having the vector sensor includes a mobile terminal having a Gyroscope and/or a Gravity sensor;

the mobile terminal acquires displacement parameters of the user's swinging; and

the first swinging control instruction which is preset is invoked when the displacement parameters are greater or equal to preset thresholds.

In addition, the step that the mobile terminal transmits the title and the link address information of the current online playing video to the digital television reception terminal according to the first swinging control instruction includes:

The mobile terminal transmits the title, the playback position, and the link address information of the current online playing video to the digital television reception terminal according to the first swinging control instruction.

In addition, the digital television reception terminal acquires the playing video to play according to the title and the link address information also includes

the digital television reception terminal acquires the playing video according to the title and the link address information and jumps to the corresponding playback position for video playing.

In addition, the method includes the following step after the digital television reception terminal acquires and plays the playing video according to the title and the link address information:

the mobile terminal acquires a second swinging control instruction of the user;

the mobile terminal transmits a stop playing instruction to the digital television reception terminal according to the second swinging control instruction; and

the digital television reception terminal stops the current video playing according to the stop playing instruction.

In addition, the method includes the following step after the digital television reception terminal stops the current video playing according to the stop playing instruction:

the digital television reception terminal transmits the title, the playback position, and the link address information of the current online playing video to the mobile terminal; and

the mobile terminal acquires the video and starts to play from the corresponding playback position according to the title, the playback position, and the link address information

To solve the problem of the invention, the invention discloses the mobile terminal, which includes:

an instruction acquiring module configured to acquire the first swinging control instruction of the user; and

a transmitting module configured to transmit the title and the link address information of the current online playing video to the digital television reception terminal according to the first swinging control instruction.

In addition, the instruction acquiring module includes:

the vector sensor, which includes the Gyroscope and/or the Gravity sensor and is configured to acquire the displacement parameters of the user's swing; and

an invoking module configured to invoke the first swinging control instruction which is preset when the displacement parameters are greater or equal to the preset thresholds.

In addition, the transmitting module is also configured to transmit the title, the playback position, and the link address information of the current online playing video to the digital television reception terminal according to the first swinging control instruction.

In addition, the instruction acquiring module is also configured to acquire the second swinging control instruction of the user;

The transmitting module is also configured to transmit the stop playing instruction to the digital television reception terminal according to the second swinging control instruction

In addition, the mobile terminal also comprises

a receiving module configured to receive the title, the playback position, and the link address information of the current online playing video from the digital television reception terminal to the mobile terminal;

a playing module configured to acquire the video and play the video from the corresponding playback position according to the title, the playback position, and the link address information.

To solve the problem of the invention, the invention discloses the digital television reception terminal, which includes

a receiving module configured to receive the title and the link address information of the current online playing video from mobile terminal according to the first swinging control instruction; and

a playing module configured to acquire and play the playing video according to the title and the link address.

In addition, the receiving module is also configured to receive the title, the playback position, and the link address information of the current online playing video, which is transmitted by the mobile terminal according to the first swinging control instruction.

In addition, the playing module is also configured to acquire the playing video and jump to the corresponding playback position to play the video according to the tile and the link address information.

In addition, the receiving module is also configured to receive the stop playing instruction, which is transmitted by the mobile terminal according to the second swinging control instruction;

The playing module is also configured to stop the video playing according to the stop playing instruction.

In addition, the digital television reception terminal also includes

a transmitting module configured to transmit the title, the playback position, and the link address information of the current online playing video to the mobile terminal when the playing module stops to playing the current playing video.

To solve the problem of the invention, the invention also provides an interaction system between the digital television reception terminal and the mobile terminal, the system comprises:

the mobile terminal having the vector sensor is configured to acquire a first swinging control instruction of the user, transmit the title and the link address information of the current online playing video to the digital television reception terminal according to the first swinging control instruction; and

the digital television reception terminal is configured to acquire an play the playing video of a video server according to the title and the link address; and

the video server is configured to provide the playing video to the mobile terminal and the digital television reception terminal.

The invention has the following advantages, as compared to prior art: by means that the user swings the mobile terminal to initiate a video playing handoff, the invention realizes the video handoff between the mobile terminal and the digital television reception terminal by a convenient operation, and improves experience of the user while being user-friendly.

### BRIEF DESCRIPTION OF THE DRAWINGS

Further description of the present invention will be illustrated, which combined with embodiments in the drawings:

FIG. 1 is a flowchart of an interaction method between a digital television reception terminal and a mobile terminal provided in an embodiment of the present invention;

FIG. 2 is a structural diagram of the mobile terminal provided in an embodiment of the present invention;

FIG. 3 is a structural diagram of the digital television reception terminal provided in an embodiment of the present invention; and

FIG. 4 is a structural diagram of an interaction system between the digital television reception terminal and the mobile terminal provided in an embodiment of the present invention.

### DETAILED DESCRIPTION OF ILLUSTRATED EMBODIMENTS

An interaction method between a digital television reception terminal and a mobile terminal, the terminals, and a system are provided in the embodiments of the invention, the digital television reception terminal can play online video instead of mobile phone by interesting control means, improving experience of user.

To further clarify the objectives, technical schemes, and advantages of the present invention, the following sections offer a detailed description of the present invention in combination with the embodiments and accompanying drawings. It should be understood that the embodiments described herein are intended only to illustrate and not to limit the invention.

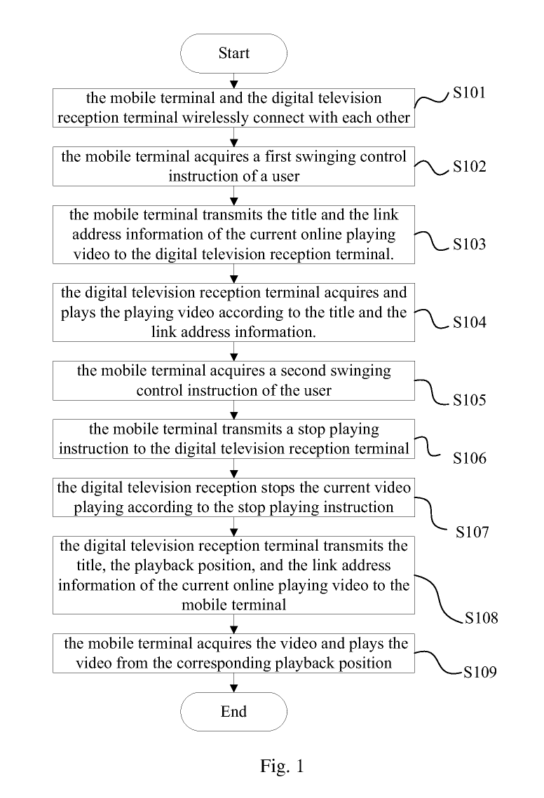

FIG. 1 is a flowchart of the interaction method between the digital television reception terminal and the mobile terminal provided in an embodiment of the present invention.

In the embodiment of the present invention, radio and television network where the digital television reception terminal is located in is based on bidirectional network, and in the bidirectional network, the digital television reception terminal can not only receive front-end broadcast but also can actively send request information to the front-end for acquiring resource.

In step S101, the mobile terminal and the digital television reception terminal wirelessly connect with each other.

In the embodiment of the present invention, the mobile terminal and the digital television reception terminal have a wireless connection function based on Wi-Fi and/or Bluetooth. The mobile terminal and the digital television reception terminal first connect with each other through Wi-Fi and/or Bluetooth when the mobile terminal and the digital television reception terminal need to interact with each other.

In step S102, the mobile terminal acquires a first swinging control instruction of a user.

In the embodiment of the present invention, the mobile terminal has a vector sensor. The vector sensor can be a Gyroscope or a Gravity sensor. A switching operation can be triggered by swinging the mobile terminal when the user wants to watch the video on the digital television reception terminal instead of being played by the mobile terminal.

In particular, the user can trigger the mobile terminal to achieve the switching operation through predetermined swing actions (e.g., swinging towards left or swinging toward left first and then right etc.), the vector sensor (can be a Gyroscope or a Gravity sensor) acquires the displacement parameters of the swing, the preset corresponding first swinging control instruction is invoked when the displacement parameters are greater or equal to the preset thresholds. That is, the swing of the user must meet preset requirements to avoid misoperations, and the mobile terminal invokes the first swinging control instruction when the user's swing meets the preset requirements.

In step S103, the mobile terminal transmits the title and the link address information of the current online playing video to the digital television reception terminal.

The mobile terminal transmits the title and the link address information of the current online playing video to the digital television reception terminal according to the first swinging control instruction after the mobile terminal invokes the first swinging control instruction, so that the digital television reception terminal can acquire the corresponding video from the front-end according to the title and the link address information.

In addition, the mobile terminal can also transmit the playback position of the current video along with the title and the link address information to the digital television reception terminal, so that the digital television reception terminal can request to play the video from the playback position when acquiring the video from the front-end.

In step S104, the digital television reception terminal acquires the playing video to play according to the title and the link address information.

The digital television reception terminal initiates video request for the title to the front-end after acquiring the title and the link address information. In addition, when the digital television reception terminal transmits the playback position along with the title and the link address information, and when the front-end supports for fixed-point play, the digital television reception terminal carries the playback position when initiating video request to the front-end. The digital television reception terminal starts to play after acquiring the video information transmitted from the front-end.

The following steps can be employed when the user wants to stop the digital television reception terminal from playing the video:

In step S105, the mobile terminal acquires a second swinging control instruction of the user;

In step S106, the mobile terminal transmits a stop playing instruction to the digital television reception terminal according to the second swinging control instruction.

In step S107, the digital television reception stops playing the current video according to the stop playing instruction.

In addition, it can be set that the mobile terminal is switched to play the video when the digital television reception terminal stops playing the video by the following steps:

In step S108, the digital television reception terminal transmits the title, the playback position and the link address information of the current online playing video to the mobile terminal.

In step S109, the mobile terminal acquires the video according to the title, the playback position and the link address information, and plays the video from the corresponding playback position.

By means that the user swings the mobile terminal to initiate a video playing handoff, the invention realizes the video handoff between the mobile terminal and the digital television reception terminal by a convenient operation, and improves experience of the user while being user-friendly.

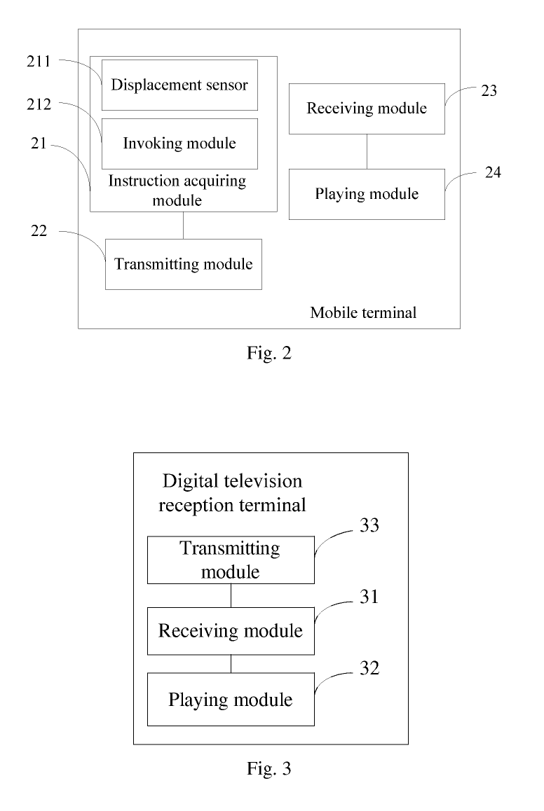

FIG. 2 is a structural diagram of the mobile terminal provided in an embodiment of the present invention;

The mobile terminal provided in an embodiment of the present invention includes:

an instruction acquiring module 21, configured to acquire the first swinging control instruction of the user; and

a transmitting module 22, configured to transmit the title and the link address information of the current online playing video to the digital television reception terminal according to the first swinging control instruction.

The instruction acquiring module 21 includes:

the vector sensor 211, including Gyroscope and/or Gravity sensor, and configured to acquire the displacement parameters of the user's swing; and

an invoking module 212, configured to invoke the first swinging control instruction when the displacement parameters are greater or equal to preset thresholds.

The transmitting module 22 is also configured to transmit the title, the playback position and the link address information of the current online playing video to the digital television reception terminal according to the first swinging control instruction.

In addition, the transmitting module 22 is also configured to transmit the stop playing instruction to the digital television reception terminal according to the second swinging control instruction.

The mobile terminal also includes:

a receiving module 23, configured to receive the title, the playback position, and the link address information of the current online playing video from the digital television reception terminal to the mobile terminal;

a playing module 24, configured to acquire the video according to the title, the playback position and the link address information, and play the video from the corresponding playback position.

In the embodiment of the present invention, the mobile terminal and the digital television reception terminal have the wireless connection function based on Wi-Fi and/or Bluetooth. The transmitting modules 22 first connect with the digital television reception terminal through by Wi-Fi and/or Bluetooth and then transmit data when the mobile terminal and the digital television reception terminal need to interact with each other.

In the embodiment of the present invention, the vector sensor 211 can be a Gyroscope or a Gravity sensor. A handoff operation can be triggered by swinging the mobile terminal when the user wants to watch the video on the digital television reception terminal instead of being played by the mobile terminal.

In particular, the user can trigger the mobile terminal to achieve the switching operation through predetermined swing actions (e.g., swing towards left or swing toward left first and then right etc.), the vector sensor 211 (can be a Gyroscope or a Gravity sensor) acquires the displacement parameters of the swing, the invoking module 212 invokes the preset corresponding first swinging control instruction when the displacement parameters are greater or equal to the preset thresholds. That is, the swing of the user must meet preset requirements to avoid misoperations, and the mobile terminal invokes the first swinging control instruction when the user's swing meets the preset requirements.

The transmitting module 22 transmits the title and the link address information of the current online playing video to the digital television reception terminal according to the first swinging control instruction after the invoking module 212 invokes the first swinging control instruction, to facilitate the digital television reception terminal to acquire the corresponding video from the front-end according to the title and the link address information.

In addition, the transmitting module 22 can transmit the playback position of the current video along with the title and the link address information to the digital television reception terminal, so that the digital television reception terminal can request to play the video from the playback position when acquiring the video from the front-end.

FIG. 3 is a structural diagram of the digital television reception terminal provided in an embodiment of the present invention;

The digital television reception terminal provided in the embodiment of the present invention, includes:

a receiving module 31, configured to receive the title and the link address information of the current online playing video from mobile terminal according to the first swinging control instruction; and

a playing module 32, configured to acquire the playing video according to the title and the link address and play the video.

In addition, the receiving module 31 is also configured to receive the title, the playback position and the link address information of the current online playing video, which is transmitted by the mobile terminal according to the first swinging control instruction.

In addition, the playing module 32 is also configured to acquire the playing video according to the tile and the link address information and jump to the corresponding playback position to play the video.

The receiving module 31 is also configured to receive the stop playing instruction, which is transmitted by the mobile terminal according to the second swinging control instruction;

the playing module 32 is also configured to stop playing the current playing video according to the stop playing instruction.

In addition, the digital television reception terminal can also include:

a transmitting module 33, configured to transmit the title, the playback position and the link address information of the current online playing video to the mobile terminal when the playing module stops playing the current playing video.

The playing module 32 initiates the request for the video request for the title to the front-end after the receiving module 31 acquires the title and the link address information. In addition, when the playing module 32 transmits the playback position along with the title and the link address information, and when the front-end supports for fixed-point play, the play module 32 carries the playback position when initiating video request to the front-end. The playing module 32 starts to play after acquiring the video information transmitted from the front-end.

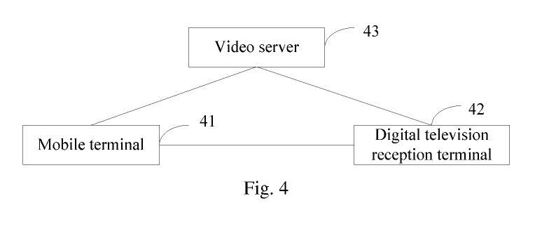

FIG. 4 is a structural diagram of an interaction system between the digital television reception terminal and the mobile terminal provided in an embodiment of the present invention.

The interaction system between the digital television reception terminal and the mobile terminal provided in an embodiment of the present invention includes:

a mobile terminal 41 having a vector sensor, configured to acquire a first swinging control instruction of the user and transmit the title and the link address information of the current online playing video to a digital television reception terminal 42 according to the first swinging control instruction;

the digital television reception terminal 42, configured to acquire the playing video from a video server 43 according to the title and the link address and play the playing video; and

the video server 43, configured to provide the playing video for the mobile terminal 41 and the digital television reception terminal 42.

In the embodiment of the present invention, the mobile terminal 41 and the digital television reception terminal 42 have wireless connection function (such as Wi-Fi and/or Bluetooth).

Further, in the embodiment of the present invention, the mobile terminal 41 can be the mobile terminal of FIG. 2 and related embodiments, and the digital television reception terminal 42 can be the digital television reception terminal of FIG. 3 and related embodiments.

The digital television reception terminal of the present invention includes, but is not limited to, a set-up box, an Internet protocol television (IPTV), an integrated digital TV, a TV mobile phone, and other terminals capable of receiving digital television.

What is said above are only preferred examples of present invention, not intended to limit the present invention, any modifications, equivalent substitutions and improvements etc. made within the spirit and principle of the present invention, should be included in the protection range of the present invention.

1. An interaction method between a digital television reception terminal and a mobile terminal, the method comprising:
the mobile terminal acquiring a first swinging control instruction of a user by a vector sensor;
the mobile terminal transmitting the title and the link address information of the current online playing video to the digital television reception terminal according to the first swinging control instruction; and
the digital television reception terminal acquiring the playing video to play according to the title and the link address information.

2. The method of claim 1, wherein the method further comprises the following step before the step of the mobile terminal acquiring the first swinging control instruction of the user by a vector sensor:
the mobile terminal and the digital television reception terminal connecting with each other through Wi-Fi or Bluetooth.

3. The method of claim 1, wherein the mobile terminal comprises at least one of the following vector sensors: gyroscope, gravity sensor;
the step of the mobile terminal acquiring the first swinging control instruction of the user by the vector sensor comprising:
the mobile terminal acquiring displacement parameters of the user's swinging; and
the first swinging control instruction which is preset being invoked when the displacement parameters are greater or equal to the preset thresholds.

4. The method of claim 3, wherein the step of the mobile terminal transmitting the title and the link address information of the current online playing video to the digital television reception terminal according to the first swinging control instruction also comprises:
the mobile terminal transmitting the playback position of the current online playing video to the digital television reception terminal according to the first swinging control instruction.

5. The method of claim 4, wherein the step of the digital television reception terminal acquiring the playing video to play according to the title and the link address information also comprises:
the digital television reception terminal acquiring the playing video according to the title and the link address information and jumping to the corresponding playback position for video playing.

6. The method of claim 1, wherein the method comprises the following step after the digital television reception terminal acquires and plays the playing video according to the title and the link address information:
the mobile terminal acquiring a second swinging control instruction of the user;
the mobile terminal transmits a stop playing instruction to the digital television reception terminal according to the second swinging control instruction; and
the digital television reception terminal stopping the current video playing according to the stop playing instruction.

7. The method of claim 6, wherein the method comprises the following step after the digital television reception terminal stops the current video playing according to the stop playing instruction:
the digital television reception terminal transmitting the title, the playback position, and the link address information of the current online playing video to the mobile terminal; and
the mobile terminal acquiring the playing video and starting to play from the corresponding playback position according to the title, the playback position, and the link address information.

8. A mobile terminal, comprising:
an instruction acquiring module, configured to acquire the first swinging control instruction of a user by a vector sensor; and
a transmitting module, configured to transmit the title and the link address information of the current online playing video to the digital television reception terminal according to the first swinging control instruction, to enable the digital television reception terminal to acquire the playing video to play according to the title and link address information.

9. The mobile terminal of claim 8, wherein the instruction acquiring module comprises:
the vector sensor, configured to acquire the displacement parameters of the user's swing and comprising at least one of a Gyroscope and/or a Gravity sensor; and
an invoking module configured to invoke the first swinging control instruction which is preset when the displacement parameters are greater or equal to the preset thresholds.

10. The mobile terminal of claim 8, wherein the transmitting module is also configured to transmit the title, the playback position, and the link address information of the current online playing video to the digital television reception terminal according to the first swinging control instruction.

11. The mobile terminal of claim 8, wherein the instruction acquiring module is also configured to acquire a second swinging control instruction of the user, and
the transmitting module is also configured to transmit a stop playing instruction to the digital television reception terminal according to the second swinging control instruction.

12. The mobile terminal of claim 11, wherein the mobile terminal also comprises:
a receiving module configured to receive the title, the playback position, and the link address information of the current online playing video from the digital television reception terminal to the mobile terminal; and
a playing module configured to acquire the video and play the video from the corresponding playback position according to the title, the playback position, and the link address information.

13. A digital television reception terminal, comprising:
a receiving module configured to receive the title and the link address information of the current online playing video from mobile terminal according to a first swinging control instruction; and
a playing module configured to acquire and play the playing video according to the title and the link address.

14. The digital television reception terminal of claim 13, wherein the receiving module is also configured to receive the title, the playback position, and the link address information of the current online playing video, which is transmitted by the mobile terminal according to the first swinging control instruction.

15. The digital television reception terminal of claim 14, wherein the playing module is also configured to acquire the playing video and jump to the corresponding playback position to play the video according to the tile and the link address information.

16. The digital television reception terminal of claim 13, wherein the receiving module is also configured to receive a stop playing instruction, which is transmitted by the mobile terminal according to a second swinging control instruction, and
the playing module is also configured to stop the video playing according to the stop playing instruction.

17. The digital television reception terminal of claim 16, wherein the digital television reception terminal also comprises:
a transmitting module configured to transmit the title, the playback position, and the link address information of the current online playing video to the mobile terminal when the playing module stops to playing the current playing video.

18. (canceled)

19. (canceled)

20. The method of claim 1, wherein the playing video is provided by a video server.

21. The mobile terminal of claim 8, wherein the playing video is provided by a video server.

22. The digital television reception terminal of claim 13, wherein the playing video is provided by a video server.
